(19) United States
(12) Patent Application Publication
(10) Pub. No.: US 2010/0056129 A1
(43) Pub. Date: Mar. 4, 2010

(54) Radio Base Station, Radio Communication Terminal, Radio Communication Method and Radio Communication System

(75) Inventor: Kenji Kono, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/096,575

(22) PCT Filed: Dec. 6, 2006
(86) PCT No.: PCT/JP2006/324362

§ 371 Date: Sep. 30, 2009

(30) Foreign Application Priority Data
Dec. 7, 2005 (JP) 2005-353077

(51) Int. Cl. H04M 3/00

(52) U.S. Cl. 455/419

(57) ABSTRACT

A radio communication terminal 300 sets a communication setting supporting rev.A and a communication setting supporting rev.0, and sets a plurality of communication settings on the basis of the a communication setting supporting rev.0 and communication setting information (rev.0-Config1, rev.0-Config2, . . . ) set for each of communication level of an application. The radio communication terminal 300 selects an appropriate communication setting from the set communication setting in accordance with an application in execution, and set communication setting with a radio base station 200.

### TECHNICAL FIELD

The present invention relates to a radio base station, a radio communication terminal, a radio communication method and a radio communication system, which are used in a radio communication system including a mixture of radio base stations having different communication capabilities.

### BACKGROUND ART

In a CDMA2000 1xEV-DO (hereinafter, referred to as 1xEV-DO) system, a reverse link data communication rate of a radio communication terminal such as a mobile telephone is controlled oh the basis of: information, “RAbit (Reverse Activity Bit)” transmitted from a base station at each predetermined timing to indicate an instruction to increase or decrease an upper limit value of the reverse link communication rate (transferred rate); and a threshold value determined when a session is established between the radio communication terminal and the radio base station.

FIG. 1 is a communication rate change test table used in a 1xEV-DO system (refer to Non-patent document 1, for example).

As shown in FIG. 1, in 1xEV-DO, an upper limit value of a reverse link communication rate is set at rive levels, 9.6 kbps, 19.2 kbps, 38.4 kbps, 76.8 kbps and 153.6 kbps. When a radio communication terminal starts communications between itself and a radio base station, the communications start at the lowest communication rate (9.6 kbps). Thereafter, the radio communication terminal receives a RAbit transmitted from the radio base station, and adjusts the communication rate on the basis of the received RAbit.

The RAbit is a bit value that changes depending on the amount of congestion at the radio base station currently connected to the radio communication terminal and at handoff target peripheral base stations. Moreover, the congestion or a radio base station refers to a situation where a large number of radio communication terminals are connected to the radio base station in a concentrated manner, or a situation where a traffic jam occurs in a communication line connected to the radio base station, or the like.

In a case where communications are not congested in a radio base station, that is, in a case where it is possible to increase the communication rate, the RAbit is set to “0.” On the other hand, in a case where communications in a radio base station are determined to be congested, that is, in a case where it is not preferable to increase the communication rate, the RAbit is set to “1.”

FIG. 7 is a flow chart showing processing for changing a data communication rate by a radio communication terminal supporting 1xEV-DO.

The radio communication terminal supporting 1xEV-DO (hereinafter, referred to as the radio communication terminal) first starts communications at the lowest communication rate (9.6 kbps) (step 9001).

Upon receipt of a RAbit from a radio base station, the radio communication terminal determines whether or not the received RAbit is “0” (step 9002). In a case where the radio communication terminal determines that the RAbit is “0” (YES in step 9002), the radio communication terminal operates to increase the current upper limit value of the communication rate by one level. In this case, the communication rate is configured to increase not always, but based on probability.

First, the radio communication terminal generates a random number x (0<x<1), (step 9003). Next, the radio communication terminal determines whether or not the generated random number x is smaller than a threshold value α for changing the communication rate (step 9004). Here, as shown in FIG. 1, the threshold value α varies depending on the current communication rate. When an upper limit value is to be increased by one level from 9.6 kbps to 19.2 kbps, the threshold value α becomes a value obtained by dividing “48” by “255,” that is, “ 48/255.” In this example, the radio communication terminal determines whether the random number x is greater or smaller than “ 48/255.”

In a case where the radio communication terminal determines that the random number x is equal to or greater than the threshold value α (YES in step 9004), the radio communication terminal increases the current upper limit value of the communication rate by one level (step 9005). For example, when the current upper limit value of the communication rate is 9.6 kbps, the radio communication terminal increases the upper limit value to 19.2 kbps, which is the level higher than the current level by one level. On the other hand, in a case where the radio communication terminal determines that the random number x is smaller than the threshold value α, the radio communication terminal maintains the current upper limit value of the communication rate (step 9006). For example, when the current upper limit value of the communication rate is 9.6 kbps, the radio communication terminal maintains the upper limit value at 9.6 kbps.

On the other hand, in a case where the radio communication terminal determines that the RAbit is “1” (NO in step 9002), the radio communication terminal operates to decrease the current upper limit value of the communication rate by one level. Specifically, the radio communication terminal generates a random number x (0<x<1) (step 9007) and compares the random number x with a threshold value α (hereinafter, a is denoted by α′ in order to distinguish from α when the RAbit-0) (step 9008). In a case where the radio communication terminal determines that the random number x is smaller than the threshold value α′ (YES in step 9008), the radio communication terminal decreases the current upper limit value of the communication rate by one level (step 9009). For example, when the current upper limit value of the communication rate is 19.2 kbps, the radio communication terminal decreases the upper limit value to 9.6 kbps, which is the level lower than the current level by one level. On the other hand, in a case where the radio communication terminal determines that the random number x is equal to or greater than the threshold value α′ (NO in step 9008), the radio communication terminal maintains the current upper limit, value of the communication rate (step 9006). For example, when the current upper limit value of the communication rate is 19.2 kbps, the radio communication terminal maintains the upper limit value at 19.2 kbps.

As described above, in a 1xEX-DO system, the radio communication terminal controls the upper limit value of a communication rate at least in reverse link communications so as to increase or decrease by one level, or to maintain the upper limit value, on the basis of a RAbit transmitted from a radio base station at each predetermined timing and of a threshold value determined when a session between the radio communication terminal and the radio base station is established.

Incidentally, development of CDMA2000 1xEV-DO rev.A (hereinafter, referred to as 1xEV-DO rev.A), which expands the communication scheme of aforementioned 1xEV-DO (hereinafter, referred to as 1xEV-DO rev.0) is currently in progress. As a function to be newly added in 1xEV-DO rev.A, there is a QoS (Quality of Service) control. According to the QoS control, packets are prioritized according to applications executed on the radio communication terminal, and packets with high priority are transferred first. Specifically, without performing the aforementioned stepwise control of a communication rate based on the probability, a reverse link communication rate required for an application to be executed on the radio communication terminal can be secured from the beginning of the communications. In addition, during the communications, the communication rate can be relatively freely changed in accordance with the communication rate required for the application.

Non-patent document 1: “cdma2000 High Rate Packet Data Air interface 3GPP2 C.S0024 Version 4.0 section 8.5.6.1.5.2 Rate Control”; (October 2002), 3GPP2.

### DISCLOSURE OF THE INVENTION

When a radio communication terminal supporting 1xEV-DO rev.A performs handoff to a radio base station supporting 1xEV-DO rev.0 while executing an application that requires a certain degree of a reverse link communication rate (transfer rate) between the radio communication terminal and a radio base station supporting 1xEV-DO rev.A, the radio communication terminal has to start communications initially at 9.6 kbps, and cannot obtain the required reverse link communication rate without performing the aforementioned communication rate increase test based on probabilities. In the aforementioned prior art, however, the increasing or decreasing of a reverse link communication rate is controlled on the basis of the same probabilities for both communications that require a certain degree or a reverse link communication rate not allowing delay, and communications that can be executed at a low communication rate, since only one threshold value α is provided to each communication rate (upper limit value).

For example, a description of a case of an IP phone will be given. In an IP phone, voice data is formed into an IP packet (VoIP), and the IP packet is delivered to another party via a normal IP network. Since a dedicated voice network (line switching network) is not used, delay occurs easily in a network path. In the specification, however, delay of a certain period of time or longer is not allowed since the application is voice communications. In other words, although a communication rate of approximately 70 to 80 kbps is required in general, communications always start at 9.6 kbps in 1xEV-DO rev.0, and the aforementioned communication rate increase test needs to be performed at least three times until the communication rate reaches the required rate. Actually, the aforementioned communication rate increase test is controlled by the probabilities, so that the probability for allowing an increase in the communication rate becomes lower as the communication rate becomes higher. It is thus required to pass the test a considerable number of times for obtaining the required communication rate. “Delay”πof an IP packet occurs therefore.

Moreover, an IP phone uses “voice activity detection,” which aims to achieve effective usage of bandwidth by not transmitting data from a party in silence, that is, by not transmitting data during a period of silence. For example, while a user is listening to another party, the radio communication terminal does not transmit voice data (IP packet), and starts transmission of voice data when the user starts talking. Specifically, in a case where the radio communication terminal executes an IP phone call in accordance with 1xEV-DO rev.0, the reverse link communication rate when the user starts talking during the call is always 9.6 kbps. Furthermore, due to the aforementioned communication rate increase test, some time is required until the required communication rate is fully achieved. In other words, delay always occurs when the user starts talking.

In this respect, an object of the present invention is to achieve, without degrading a quality of service for an application in execution, handoff from a radio base station able to allocate a desired reverse link communication rate to a radio base station that controls a reverse link communication rate by changing an upper limit value of the reverse link communication rate in a stepwise manner.

In order to solve the aforementioned problem, a radio base station according to an aspect of the present invention is summarized as a radio base station comprising: a communication setting information storage unit configured to store plural pieces of communication setting information each having a different change rate for changing an upper limit value of a reverse link communication rate in a stepwise manner; and a communication setting unit configured to set a plurality of communication settings with a radio communication terminal on the basis of the communication setting information stored in the communication setting information storage unit.

A radio communication terminal according to an aspect of the present invention is summarised as a radio communication terminal comprising: a communication setting unit configured to set a plurality of communication settings with a radio base station, each of the communication settings having a change rate for changing an upper limit value of a reverse link communication rate in a stepwise manner; a communication setting retention unit configured to retain the communication settings; and a communication setting establishment unit configured to select a communication setting from the communication setting retention unit in accordance with a reverse link communication rate required for an application in execution, and to establish communication with a different radio base station by use of the selected communication setting, when handoff from the radio base station to the different, radio base station having a different communication capability is performed.

Furthermore, the radio communication terminal according to an aspect of the present invention is characterized in that the communication setting unit sets the communication settings when the radio communication terminal is powered on.

In addition, the radio communication terminal of the present invention is summarized as the radio communication terminal in which the communication setting unit sets the communication settings when the radio communication terminal starts communication with the radio base station.

A radio communication method according to an aspect of the present invention is summarised as a radio communication method comprising: setting a plurality of communication settings with a radio base station, each of the communication settings having a different change rate for changing an upper limit value of a reverse link communication rate in a stepwise manner, while retaining the communication settings; selecting a communication setting from the communication settings in accordance with a reverse link communication rate required for an application in execution, when handoff from the radio base station to a different radio base station having a different communication capability is performed; and establishing communication with the different radio base station by use of the selected communication setting.

A radio communication system according to an aspect of the present invention is summarized as a radio communication system comprising: a first radio base station capable of allocating a desired reverse link communication rate; a second radio base station configured to control a communication rate by changing an upper limit value of the communication rate in a stepwise manner; and a radio communication terminal capable of communicating with the first radio base station and the second radio base station, wherein the first radio base station includes: a communication setting information storage unit configured to store plural pieces of communication setting information each having a different change rate for changing an upper limit value of a reverse link communication rate in a stepwise manner; and a communication setting unit configured to set a plurality of communication settings with the radio communication terminal on the basis of the communication setting information stored in the communication setting information storage unit, the radio communication terminal includes: a communication setting unit configured to set a plurality of communication settings with the first radio base station, each of the communication settings having a different change rate for changing an upper limit value of a reverse link communication rate in a stepwise manner; a communication setting retention unit configured to retain the communication settings; and a communication setting establishment unit configured to select a communication setting from the communication setting retention unit in accordance with a reverse link communication rate required for an application in execution, and to establish communication with the first radio base station by use of the selected communication setting, when handoff from the first radio base station to the second radio base station is performed.

Specifically, according to an aspect of the present invention, handoff from a radio base station able to assign a desired reverse link communication rate to a radio base station that controls the reverse link communication rate by changing the upper limit value of the reverse link communication rate (transfer rate) can be performed without degrading a quality of service of an application in execution.

### BRIEF DESCRIPTION OF THE DRAWINGS

FIG. 1 is a diagram showing a conventional communication rate change test table.

FIG. 2 is a diagram showing an operation flow of a communication rate change of a conventional radio communication terminal.

FIG. 3 is an entire schematic configuration diagram of a radio communication system according to an embodiment of the present invention.

FIG. 4 is a functional block configuration diagram of a radio base station according to the embodiment of the present invention.

FIG. 5 is a detailed functional block diagram of a system controller and a system memory of the radio base station according to the embodiment of the present invention.

FIG. 6 is a detailed functional block diagram of a system controller and a system memory of a radio base station according to the embodiment of the present invention.

FIG. 7 is a functional block diagram of a radio communication terminal according to the embodiment of the present invention.

FIG. 8 is a detailed functional block diagram of a system controller and a system memory of the radio communication terminal according to the embodiment of the present invention.

FIG. 9 is a diagram showing an example of a communication rate change test table according to the embodiment of the present invention.

FIG. 10 is a diagram showing an operation flow of a radio base station according to the embodiment of the present invention.

FIG. 11 is a diagram showing an operation flow of the radio communication terminal according to the embodiment of the present invention.

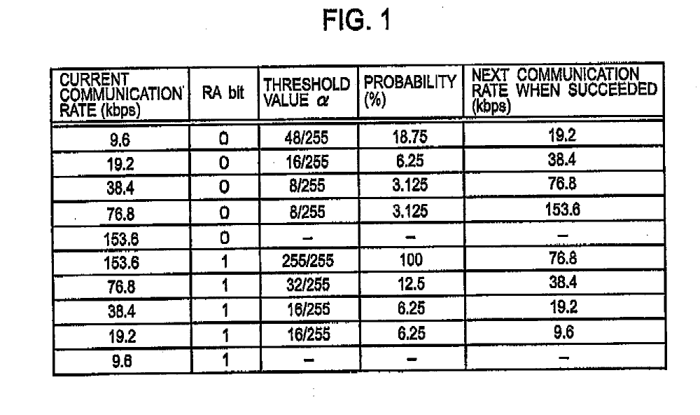

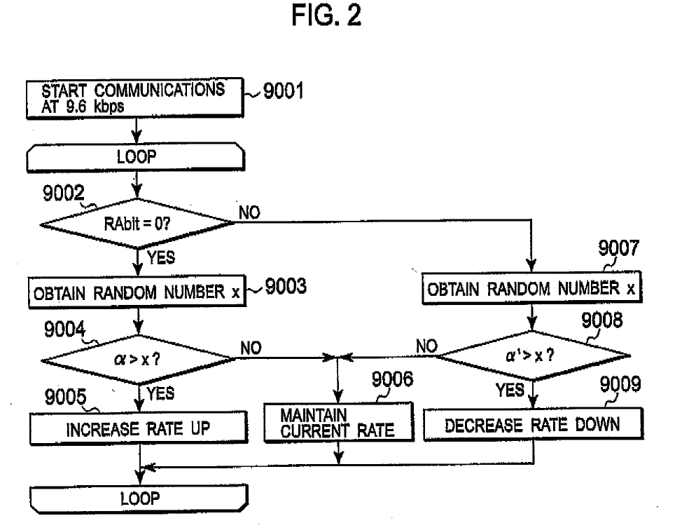

### BEST MODE FOR CARRYING OUT THE INVENTION

Hereinafter, an embodiment of the present invention will be described in detail.

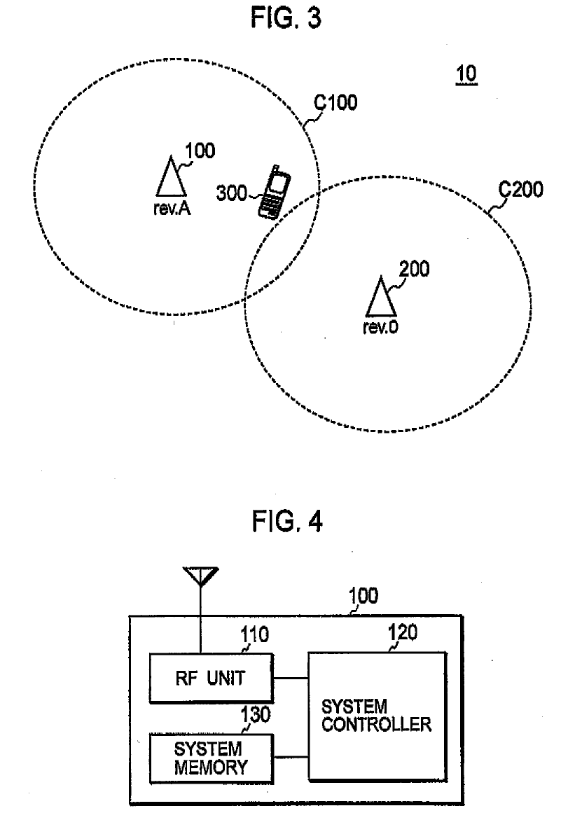

FIG. 3 is an entire schematic configuration diagram of a radio communication system according to the embodiment of the present invention.

A radio communication system 10 shown in FIG. 3 is configured of a plurality of radio base stations (base stations 100 and 200) and a radio communication terminal 300. Note that the numbers of radio base stations and radio communication terminals constituting the radio communication system 10 are not limited to the numbers of those shown in FIG. 3.

The radio communication system 10 is a radio communication system in accordance with a CDMA2000 scheme, and employs multiple schemes having different communication capabilities as the data communication schemes.

Specifically, 1xEV-DO rev.0 (hereinafter, referred to as rev.0) and 1xEV-DO rev.A (hereinafter, referred to as rev.A) are employed. Moreover, rev.0 achieves a reverse link data rate of 153. 6 kbps and a forward link data rate of approximately 2.4 Mbps, while rev.A achieves a reverse link data rate of approximately 1.8 Mbps and a forward link data rate of approximately 3.1 Mbps.

The radio base station 100 is a radio base station supporting rev.0 and rev.A. The radio base, station 200 is a radio base station supporting only rev.0. The radio base stations 100 and 200 respectively form cells C100 and C200.

The radio communication terminal 300 is a terminal device supporting rev.0 and rev.A and executes communications with the radio base stations 100 and 200.

FIG. 4 is a block configuration diagram of the radio base station 100.

As shown in FIG. 4, the radio base station 100 is provided with an RF unit 110, a system controller 120 and a system memory 130.

The RF unit 110 transmits and receives a radio signal in accordance with CDMA to and from the radio communication terminal 300. Moreover, the RF unit 110 executes conversion of the radio signal into a baseband signal and transmits and receives the baseband signal to and from the system controller 120.

The system controller 120 controls various types of functions included in the radio base station 100. A description of a more detailed functional block diagram of the system controller 120 related to the present embodiment will be given later.

The system memory 130 stores, therein, various types of information used in a control or the like performed in the radio base station 100. A description of more detailed functional blocks of the system memory 130 related to the present embodiment will be given later.

Moreover, the radio base station 200 supporting only rev.0 is provided with an RF unit 110, a system controller 120′ and a system memory 130′. Note that since the blocks included in the radio base station 200 operate, as a 1xEV-DO radio base station, substantially in the same manner as the respective functional blocks of the aforementioned radio base station 100, descriptions of those will be omitted herein. The descriptions of differences between the blocks of the radio base station 100 and the respective blocks of the radio base station 200 will be given later.

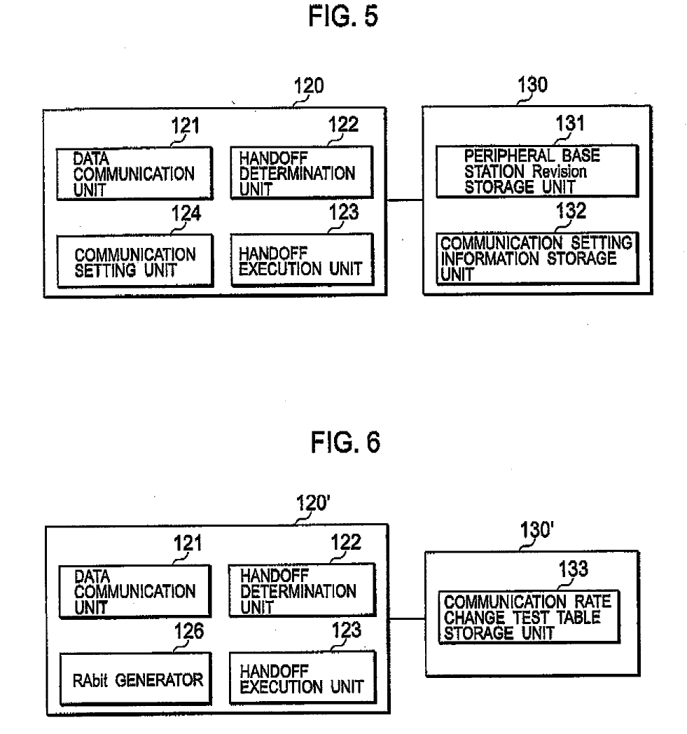

FIG. 5 is a detailed functional block configuration diagram of the system controller 120 and the system memory 130 of the radio base station 100.

As shown in FIG. 5, the system controller 120 of the radio base station 100 is provided with a data communication unit 121, a handoff determination unit 122, a handoff execution unit 123 and a communication setting unit 124.

Furthermore, the system memory 130 is provided with a peripheral base station Revision storage unit 131 and a communication setting information storage unit 132.

The data communication unit 121 executes processing related to transmission and receipt of image contents, music contents or the like, or transmission and receipt of various types of control information.

The handoff determination unit 122 determines, on the basis of a status such as the status of a radio signal transmitted from and received by the RF unit 110, whether or not to execute handoff of the radio communication terminal 300 executing communications with the radio base station 100.

The handoff execution unit 123 executes handoff of the radio communication terminal 300 on the basis of a result of a determination made by the handoff determination unit 122.

The communication setting unit 124 sets a communication setting including a QoS level, a data rate, various types of protocols and the like be executed between the radio communication terminal 300 and the radio base station 100. Particularly, in this embodiment, the communication setting unit 124 sets, in accordance with a reverse link communication rate (communication level) required for an application, a communication setting further including information in a communication rate change test table 150 included in the radio communication terminal 300 to be described later.

The periphery base station Revision storage unit 131 stores, therein, a Revision (rev.0 or rev.A) supported by a radio base station (radio base station 200, for example) arranged around the radio base station 100.

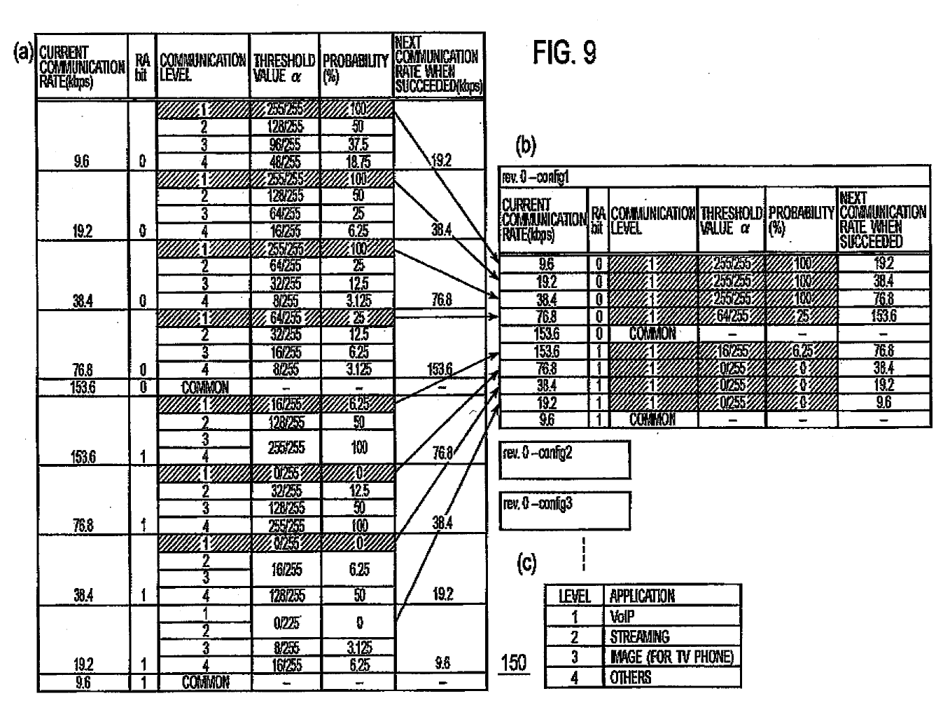

The communication setting information storage unit 132 stores, therein, a plurality of pieces of Confi communication setting information each indicating contents of a communication setting corresponding to a communication capability. In this embodiment, the communication setting information storage unit 132 stores pieces of communication setting information corresponding to rev.0 and rev.A, respectively. Moreover, in this embodiment, the communication setting information storage unit 132 stores, on the basis of the communication rate change test table 150 included in the radio communication terminal 300 to be described later, a plurality of types of pieces of communication setting information (rev.0-Config1, rev.0-Config2, and so forth) in accordance with communication levels of applications as shown in FIG. 9(b). In addition, each of the pieces of communication setting information includes a QoS control, a data rate, or a stream or the like used in data communications. Moreover, in this embodiment, each of the pieces of communication setting information also includes contents of the communication rate change test table 150 to be described later.

FIG. 6 is a detailed functional block configuration diagram of the system controller 120′ and the system memory 130′ of the radio base station 200.

Note that a description of a portion that is the same as that of the configuration of the system controller 120 of the radio base station 100 will be omitted.

As shown in FIG. 6, the system controller 120′ of the radio base station 200 is provided with a data communication unit 121′, a handoff determination unit 122′, a handoff execution unit 123′ and a RAbit generator 125.

Moreover, the system memory 130′ is provided with a communication rate change test table storage unit 133.

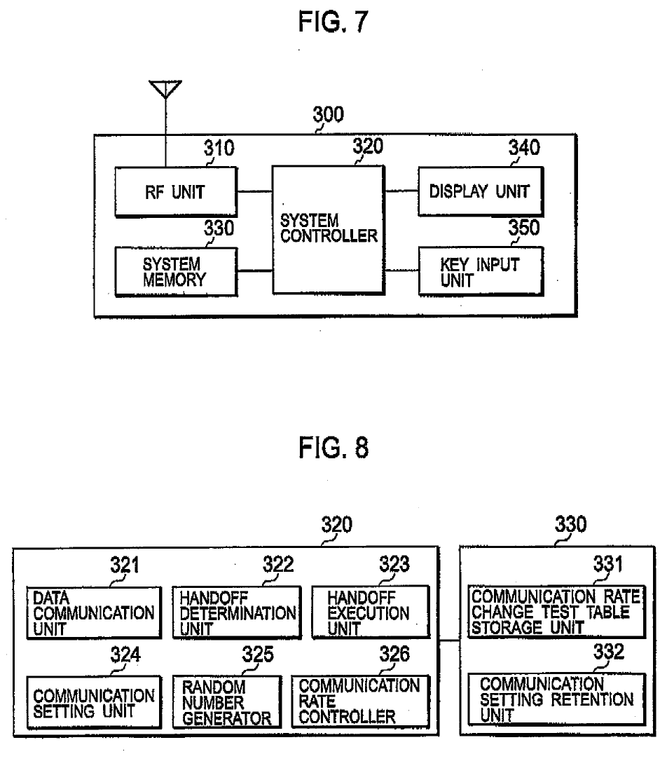

FIG. 7 is a block configuration diagram of the radio communication terminal 300.

As shown in FIG. 7, the radio communication terminal 300 is provided with an RF unit 310, a system controller 320 and a system memory 330, a display unit 340 and a key input unit 350.

The RF unit 310 transmits and receives a radio signal in accordance with CDMA between itself and the radio base station 100, and between itself and the radio base station 200. In addition, the RF unit 310 demodulates the radio signal and transmits and receives the demodulated received data to and from the system controller 320.

The system controller 320 controls various types of functions included in the radio communication terminal 300. A description of a functional block diagram of the system controller 320 related to the present embodiment will be given later in more detail.

The system memory 330 stores, therein, various types of information used in a control or the like performed in the radio communication terminal 300. A description of the functional blocks of the system memory 330 related to the present, embodiment will be given later in more detail.

The display unit 340 displays image contents or the like received via the RF unit 310 and the system controller 320, or displays operation contents (an input phone number, address or the like).

The key input unit 350 is configured of a ten key, function keys, or the like and is an interface used for inputting operation contents by the user.

FIG. 8 is a detailed functional block configuration diagram of the system controller 320 and the system memory 330.

As shown in FIG. 8, the system controller 320 is provided with a data communication unit 321, a handoff determination unit 322, a handoff execution unit 323, a communication setting unit 324, a random number generator 325 and a communication rate controller 326.

In addition, the system memory 330 is provided with a communication rate change test table storage unit 331 and a communication setting retention unit 332.

The data communication unit 321 transmits, to a handoff source base station executing data communications, a RouteUpdate message (candidate base station notification), which is a notification that predetermined radio base stations including a radio base station having a communication capability different from that of the radio base station currently executing the data communications are set as handoff destination candidate base stations.

In addition, the data communication unit 321 receives a RAbit periodically transmitted from a radio base station supporting rev.0.

The handoff determination unit 322 determines whether or not a base station having a communication capability different from that of the handoff source base station is included in the handoff destination candidate base stations.

The handoff execution unit 323 executes handoff between radio base stations.

The communication setting unit 324 sets a communication rate in accordance with an application to be executed. In this embodiment, the communication setting unit 324 sets a communication setting including a QoS level, a data rate, various types of protocols and the like for communications to be executed between the radio communication terminal 300 and the radio base station 100. Particularly, in this embodiment, the communication setting unit 324 sets a communication setting further including information in the communication rate change test table 150 to be described later.

Moreover, the communication setting unit 324 selects, from the plurality of communication settings stored in the communication setting retention unit 332, an optimum communication setting for the application in execution, as will be described later. The communication setting unit 324 then establishes communications with the radio base station by use of the selected communication setting. In this embodiment, the communication setting unit 324 constitutes a communication setting establishment unit.

The random number generator 325 generates a random number x (0<x<1) periodically at a predetermined timing.

The communication rate controller 326, on the basis of the communication setting set by the communication setting unit 324, controls a reverse link communication rate by use of the random number x generated by the random number generator 325 and of a RAbit received periodically from the radio base station.

The communication rate change test table storage unit 331 stores the communication rat(c) change test table 150 to be described later.

The communication setting retention unit 332 stores, therein, all of the plurality of communication settings set for communications with a radio base station supporting rev.A (radio base station 100).

FIG. 9(a) is a diagram showing the communication rate change test table 150.

In FIG. 9(a), the communication rate change test table 150 is different from a conventional communication rate change test table in a point that a plurality of communication levels are provided in association with each of upper limit values respectively of reverse link communication rates (transfer rates), and a threshold value of the aforementioned probability test (a rate of change of an upper limit value of a reverse link communication rate) is provided for each of the communication levels.

Note that each of the communication levels is a value to be set on the basis of a reverse link communication rate required for an application, and the communication levels are set at four levels in accordance with applications as shown in FIG. 9(a), for example. In addition, in this embodiment, values at four levels from 1 to 4 for each of the upper limit values of the reverse link communication rate are associated with applications.

The method of associating the communication levels with applications is not limited to this, however. The values may be set at three levels for each of the upper limit values of the communication rate. Moreover, a different level may be set for each of the upper limit values (four levels for 9.6 kbps, three levels for 19.2 kbps, and the like, for example). As a matter of course, the values of threshold value α are not limited to the values used in this embodiment.

According to the communication rate change test table 150, in a case where the communication level of an application is determined to be “1” while RAbit=0 (in other words, in a case where it is possible to increase the communication rate), the upper limit value of the communication rate is always increased to 19.2 kbps, which is the next level, since the threshold value α corresponding to the communication level “1” at 9.6 kbps is “ 255/255,” and α>x (0<x<1) becomes always true (probability 100%). Likewise, since the threshold value α at 19.2 kbps and 38.4 kbps is “ 255/255,” in a case where the communication level is “1, ” the upper limit value is always increased to the next level.

Specifically, according to the communication rate change test table 150, for an application whose communication level is set to be “1,” the upper limit value of the communication rate is surely increased to 76.8 kbps after the change test is performed three times.

Moreover, in a case where RAbit=1 as well (in other words, in a case where it is not preferable to increase the communication rate) and where the communication level of the application is “1,” the communication rate can be maintained at 76.8 kbps since the threshold value α corresponding to the communication level “1” at 76.8 kbps is always “ 0/255,” for example, and α<x (0<x<1) is always true (probability 100%).

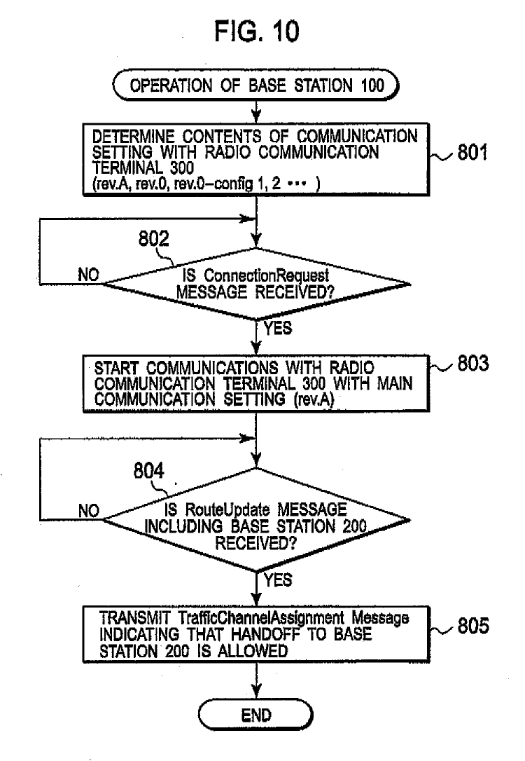

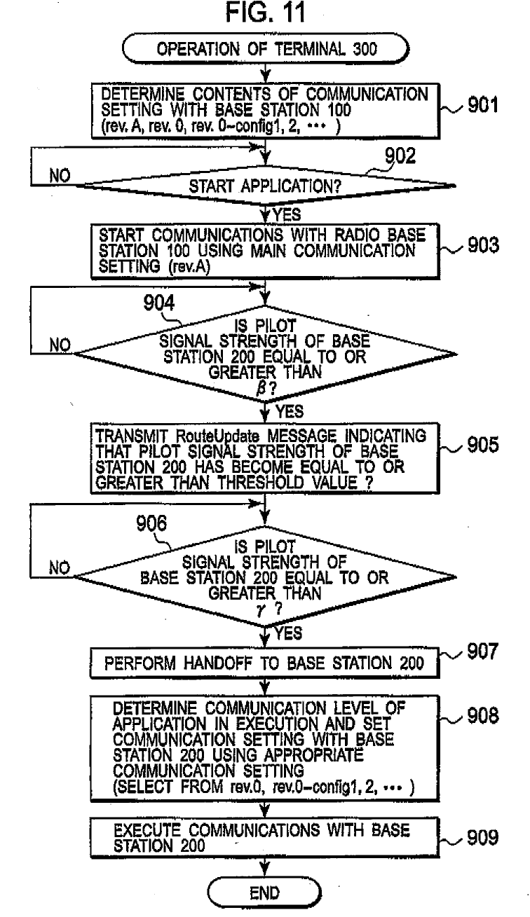

FIG. 10 is a flow chart showing an operation of the radio base station 100 in detail.

Note that a description of this embodiment will be given based on an assumption that handoff from a rev.A base station to a rev.0 base station is performed.

The radio base station 100 determines, on the basis of the plurality of pieces of communication setting information stored in the communication setting information storage unit 132, contents of a communication setting corresponding to rev.A as a “main communication setting” and contents of a communication setting corresponding to rev.0 as a “sub communication setting.” In addition, the radio base station 100 determines contents of a communication setting as a “level n communication setting” (n is a value indicating the level) on the basis of the sub communication setting and the aforementioned pieces of the communication setting information (rev.0-Config1, rev-0-config2 and so forth) set for each of the communication levels of applications (refer to FIG. 9(b)) (step 801).

Note that the “level n communication settings” are set for the number of communication levels, for example, a “level 1 communication setting,” a “level 2 communication setting” and so forth.

Subsequently, upon receipt of a ConnectionRequest message from the radio communication terminal 300 (YES in step 802), the radio base station 100 starts data communications with the terminal device 300 in accordance with the main communication setting (rev.A) (step 803).

Subsequently, the radio base station 100 determines whether or not the radio base station 100 has received, from the radio communication terminal 300, a RouteUpdate message, that is, a RouteUpdate message indicating that the pilot signal strength of the radio base station 200 has become equal to or greater than a threshold value β (step 804).

Upon receipt of the RouteUpdate message indicating that the pilot signal strength of the radio base station 200 has become equal to or greater than the threshold value β (YES in step 804), the radio base station 100 transmits, to the radio communication terminal 300, a T-CH Assignment message indicating that handoff to the radio base station 200 is allowed (step 805).

Specifically, the radio base station 100 assigns, to the radio communication terminal 300 (step 805), a TrafficChannel for the radio base station 100 at the point when the radio base station 200 has become a handoff destination candidate base station (step 804).

Note that in step 805, the radio base station 100 determines a revision of the radio base station 200 on the basis of the peripheral base station Revision storage unit 131, and then notifies the radio communication terminal 300 of the revision.

FIG. 11 is a flow chart showing an operation of the radio communication terminal 300 in detail.

The radio communication terminal 300 determines contents of a communication setting corresponding to rev.A as a “main communication setting” and contents of a communication setting corresponding to rev.0 as a “sub communication setting” for the radio base station 100. In addition, the radio communication terminal 300 determines contents of a communication setting as a “level n communication setting” (n is a value indicating the level) on the basis of the sub communication setting and the aforementioned pieces of the communication setting information (rev.0-Config1, rev.0-config2 and so forth) set for each of the aforementioned communication levels of applications (refer to FIG. 9(b)) (step 901).

Note that the “level n communication settings” can be set for the number of communication levels, for example, “level 1 communication setting,” “level 2 communication setting” and so forth.

Moreover, as the timing of performing the aforementioned communication settings, the communication settings may be set as appropriate, for example, when the power of the radio communication terminal 300 is turned on within the cell C100, which is the control area of the radio base station 100, when the radio communication terminal 300 starts communications within the cell C100, or the like.

Subsequently, upon start of an application within the area of the radio base station 100 (YES in step 902), the radio communication terminal 300 starts data communications with the radio base station 100 in accordance with the main communication setting (rev.A) (step 903).

When the radio communication terminal 300 determines whether or not the pilot signal strength of the radio base station 200 is equal to or greater than the threshold value β, and then determines that the pilot signal strength of the radio base station 200 is equal to or greater than the threshold value β, while executing communications with the radio base station 100, the radio communication terminal 300 transmits, to the radio base station 100, a RouteUpdate message indicating that the pilot signal strength of the radio base station 200 has become equal to or greater than the threshold value β (step 905).

In other words, in step 905, the radio communication terminal 300 notifies the radio base station 100 that the radio base station 200 is a handoff destination candidate base station.

In addition, in this embodiment, a TrafficChannel for the radio base station 200 is assigned by the radio base station 100 at this point (step 805 in FIG. 10).

Subsequently, the radio communication terminal 300 determines whether or not the pilot signal strength of the radio base station 200 is equal to or greater than a predetermined threshold value γ (step 906). When the radio communication terminal 300 determines that the pilot signal strength of the radio base station 200 is equal to or greater than the predetermined threshold value γ (YES in step 906), the radio communication terminal 300 performs handoff to the radio base station 200 (step 907).

Note that after transmitting a RouteUpdate message indicating that the pilot signal strength of the radio base station 200 has become equal to or greater than the predetermined threshold value β (step 905), the radio communication terminal 300 recognizes the revision of the radio base station 200 by receiving the revision of the radio base station 200 notified by the radio base station 100.

Accordingly, the handoff from the radio base station 100 to the radio base station 200 is handoff from rev.A to rev.0. The radio communication terminal 300 thus determines the communication level of an application in execution, then selects a communication setting appropriate for the application from the communication setting retention unit 332 and notifies the radio base station 200 of the selected communication setting (step 909). Then, the radio communication terminal 300 executes communications with the radio base station 200 on the basis of the communication setting (step 910).

Note that although in the aforementioned embodiment, the radio communication terminal 300 sets the communication setting for rev.0 in accordance with the communication level of an application in execution after handoff to the radio base station 200 is performed, it is not limited to this. The radio communication terminal 300, however, may change the communication setting at the timing when a TrafficChannel is assigned by the radio base station 100, when the radio communication terminal 300 notifies the radio base station 100 of the radio base station 200 as the handoff destination candidate base station (step 905), for example. Alternatively, a configuration in which the communication setting is changed to another immediately before handoff (between steps 906 and 907) may be employed.

Moreover, although in the aforementioned embodiment, the radio base station 100 assigns a TrafficChannel for the radio base station 100 to the radio communication terminal 300 at the point when the radio base station 200 has become a handoff destination candidate base station, it is not limited to this. The radio base station 100 may be configured to assign a TrafficChannel immediately before handoff, by receiving from the radio communication terminal 300 a notification that the pilot signal strength of the radio base station 200 has become equal to or greater than the predetermined threshold value γ, for example.

Furthermore, the present invention is not limited to the aforementioned embodiment, and includes the following modification example, for example.

### MODIFICATION EXAMPLE 1

The radio base station 100 previously obtains from the radio communication terminal 300 the communication level (or a level n communication setting corresponding to the communication level) of an application being executed by the radio communication terminal 300. The radio base station 100 notifies the radio base station 200 of the obtained communication level when the radio communication terminal 300 performs handoff to the radio base station 200.

As the handoff of the radio communication terminal 300 from the radio base station 100 is performed, the radio base station 200 notifies the radio communication terminal 300 of the communication level previously notified by the radio base station 100 (or the level n communication setting corresponding to the communication level). The radio base station 200 and the radio communication terminal 300 communicate with each other by use of the communication setting corresponding to the notified communication level (or the level n communication setting corresponding to the communication level).

Note that the timing when the radio base station 100 notifies the radio base station 200 of the communication setting is not limited to the aforementioned one. The radio base station 100 may notify the radio base station 200 of the communication setting at the timing when the radio base station 200 has become a handoff destination candidate base station, for example.

### MODIFICATION EXAMPLE 2

In the aforementioned embodiment, the radio base station 100 previously assigns a TrafficChannel for the radio base station 100 (for rev.0) to the radio communication terminal 300 prior to the handoff. Specifically, two TrafficChannels are allocated between the radio base station 100 and the radio communication terminal 300.

However, in a case where an allocation of only one TrafficChannel between the radio base station 100 and the radio communication terminal 300 is allowed, as in the base of handoff between PCFs (base station control stations), for example, the present invention can be applied.

Specifically, without performing processing for transmitting a T-CH Assignment message to the radio communication terminal 300 in step 805, the radio base station 100 disconnects communications by transmitting a ConnectionClose message when it is determined to perform handoff by receiving the notification, from the radio communication terminal 300, that the pilot signal strength of the radio base station 200 has become equal to or greater than the predetermined threshold value γ.

After disconnecting the communications with the radio base station 100, the radio communication terminal 300 selects, from the communication setting retention unit 332, a communication setting appropriate to the communication level of an application in execution and notifies the radio base station 200 of the selected communication setting. Subsequently, the radio communication terminal 300 starts communications with the radio base station 200 on the basis of the communication setting.

As described above, according to the aforementioned configuration, during execution of an application that requires a certain degree of a reverse link communication rate (such as VoIP) in a rev.A environment, when handoff to the rev.0 support radio base station is performed, it is possible to surely increase, by setting a communication setting taking the reverse link communication rate required for the application into consideration, the upper limit value of the reverse link communication rate until the communication rate required for the application is achieved immediately after the handoff to the rev.0 support radio base station is performed. The user is thus able to continue to use the application without concern for delay due to the handoff from the rev.A support radio base station to the rev.0 support radio base station.

In particular, in this embodiment, a plurality of communication settings in consideration of reverse link communication rates required for applications are previously set as communication settings for rev.0 during communications with a rev.A support radio base station. Then, when handoff to a rev.0 support radio base station is performed, an optimum communication setting can be selected from the plurality of communication settings in accordance with an application in execution. Thereby, it enables smoother handoff.

Note that the entire contents of Japanese Patent Application No. 2005-353077 (filed on Dec. 7, 2005) are incorporated in this description herein by reference.

### INDUSTRIAL APPLICABILITY

As has been described so far, a radio base station, a radio communication terminal, a radio communication method and a radio communication system according to the present invention are advantageous in radio communications such as mobile communications, since they enable, without degrading a quality of service for an application in execution, handoff from a radio base station capable of assigning a desired reverse link communication rate, to a radio base station that controls a reverse link communication rate by changing an upper limit value of the reverse link communication rate in a stepwise manner.

1. A radio base station comprising:
a communication setting information storage unit configured to store plural pieces of communication setting information each having a different change rate for changing an upper limit value of a reverse link communication rate in a stepwise manner; and
a communication setting unit configured to set a plurality of communication settings with a radio communication terminal on the basis of the communication setting information stored in the communication setting information storage unit.

2. A radio communication terminal comprising:
a communication setting unit configured to set a plurality of communication settings with a radio base station, each of the communication settings having a change rate for changing an upper limit value of a reverse link communication rate in a stepwise manner;
a communication setting retention unit configured to retain the communication settings; and
a communication setting establishment unit configured to select a communication setting from the communication setting retention unit in accordance with a reverse link communication rate required for an application in execution, and to establish communication with a different radio base station by use of the selected communication setting, when handoff from the radio base station to the different radio base station having a different communication capability is performed.

3. The radio communication terminal according to claim 2, wherein the communication setting unit sets the communication settings when the radio communication terminal is powered on.

4. The radio communication terminal according to claim 2, wherein the communication setting unit sets the communication settings when the radio communication terminal starts communication with the radio base station.

5. A radio communication method comprising:
setting a plurality of communication settings with a radio base station, each of the communication settings having a different change rate for changing an upper limit value of a reverse link communication rate in a stepwise manner, while retaining the communication settings;
selecting a communication setting from the communication settings in accordance with a reverse link communication rate required for an application in execution, when handoff from the radio base station to a different radio base station having a different communication capability is performed; and
establishing communication with the different radio base station by use of the selected communication setting.

6. A radio communication system comprising:
a first radio base station capable of allocating a desired reverse link communication rate;
a second radio base station configured to control a reverse link communication rate by changing an upper limit value of the reverse link communication rate in a stepwise manner; and
a radio communication terminal capable of communicating with the first radio bass station and the second radio base station, wherein
the first radio base station includes:
a communication setting information storage unit configured to store plural pieces of communication setting information each having a different change rate for changing an upper limit value of a reverse link communication rate in a stepwise manner; and
a communication setting unit configured to set a plurality of communication settings with the radio communication terminal on the basis of the communication setting information stored in the communication setting information storage unit,
the radio communication terminal includes;
a communication setting unit configured to set a plurality of communication settings with the first radio base station, each of the communication settings having a different change rate for changing an upper limit value of a reverse link communication rate in a stepwise manner;
a communication setting retention unit configured to retain the communication settings; and
a communication setting establishment unit configured to select a communication setting from the communication setting retention unit in accordance with a reverse link communication rate required for an application in execution, and to establish communication with the second radio base station by use of the selected communication setting, when handoff from the first radio base station to the second radio base station is performed.
